(19) United States
(12) Patent Application Publication
(10) Pub. No.: US 2011/0271531 A1
(43) Pub. Date: Nov. 10, 2011

(54) OPENING AND CLOSING MECHANISM FOR UTILITY KNIFE

(76) Inventor: Chin-Chen HUANG, Taichung (TW)

(21) Appl. No.: 12/773,153

(22) Filed: May 4, 2010

(51) Int. Cl. B26B 1/08; B26B 29/02

(52) U.S. Cl. 30/162; 30/335

(57) ABSTRACT

The invention is related to a shell opening and closing mechanism for utility knife. The utility knife comprises an upper shell, a lower shell and a lock button in the terminal end of the upper shell. Mainly, the upper shell and the lower shell are assembled into one unit in the middle through an axle. Thus, the two shells can open or close to each other by rotation. Further, the lock button in the terminal end of the upper shell provides closing lock. Thus, the utility knife is provided with operational safety and convenience. Moreover, the front of the shells of the utility knife bears maximum deviated cutting force and therefore safety is enhanced when the blade in cutting.

### BACKGROUND OF THE INVENTION

1. Field of the Invention

The invention is related to opening and closing mechanism for utility knife to replace blade, especially an easy-operation and safe opening and closing mechanism for utility knife.

2. Description of the Prior Art

A common utility knife comprises shells for user to grasp and exert force, a blade holder inside the shell front to hold a protruding blade that usually is trapezoidal and the cutting edge forms two sharp points to complement each other in cutting, and a storage compartment inside the shells for storing several spare blades. Therefore, the shells of a utility knife provide the basic functions in opening for replacing blade and closing for hand-grasping. Please refer to U.S. Pat. Nos. 5,121,544 and 5,864,952 and 6,317,985 for the known technologies for utility knife shells with the basic functions in opening for replacing blade and closing for hand-grasping. In the known technologies, there are an upper shell and a lower shell that can open and close to each other. Along the peripherals of the upper shell and the lower shell, there are alternating concave edge and convex edge to match to each other and provide locking in closing. In the middle of the shells, there is a lock-button to secure the locking of the upper shell and lower shell and prevent separation of the upper shell from the lower shell when the utility knife opens to replace blade. To improve the accuracy of closing, the known technologies combine the terminal ends of the upper shell and the lower shell. Nevertheless, a thorough understanding of the disclosed shells for utility knife with known technologies finds the following drawbacks:

Firstly, opening the shells requires one hand to press the lock button and the other to hold the shells. Obviously, there is instability and difficulty associated with opening the shells.

Secondly, the shell opening process involves the upper shell lifting up by 90 degrees or to complete separation from the lower shell, and then the closing process has the risk potential of severe falling.

Thirdly, because the lock button is located in the middle of shells, it limits the quantity of stored spare blades.

Fourthly, because the lock button is located in the middle of shells to provide tightening in closing and its front only provides snap-in lock through concave and convex edges, during cutting, the deviated cutting force has the risk potential of opening up the shell front.

The above drawbacks with the utility knife of known technologies have been long criticized by the manufacturers and the consumers. Thus, it is necessary to have an easy-operation and safe shell opening and closing mechanism. This is the driving force for the invention.

### SUMMARY OF THE INVENTION

The main objective for the invention is to provide a shell opening and closing mechanism for utility knife. The utility knife shall have an upper shell and a lower shell, which combine in the middle to be able to open or close by rotating to each other. As a result, the lock button can be located in the end of the upper shell and provides the utility knife shells with safety and convenience in opening and closing.

Another objective for the invention is to provide a shell opening and closing mechanism for utility knife, which enables shell opening and closing by rotating shells and allows the shell front to support maximum deviated cutting force by improving the adhering of the fronts of upper shell and lower shell. Therefore, the cutting safety is assured.

Another objective for the invention is to provide a shell opening and closing mechanism for utility knife, which in addition to improving the adhering of the fronts of upper shell and lower shell further prevents thumb cutting injury due to slippage by a snap-in edge design on the upper shell with a force-exerting portion for the thumb to press and push.

Another objective for the invention is to provide a shell opening and closing mechanism for utility knife, which allows a single hand to complete opening and closing by rotating shells.

### DETAILED DESCRIPTION OF THE INVENTION

To further understand the features and the functions for the shell opening and closing mechanism for the utility knife in the invention, a preferred embodiment is provided with illustrative figures in the following:

Please refer to FIG. 1. The utility knife in the invention comprises an upper shell 10, a lower shell 20 and a lock button 30 in the end of the upper shell 10. On the upper shell 10 the exterior forms a handle 11 and the interior forms a blade restrictive surface 12. The outer side of the restrictive surface 12 forms a snap-in edge 13 with a groove 131. In the middle of the shell interior there is a shaft block 14 with a through-hole 141. In the end of the shell interior there is a snap-in hole 15 and two buckles 16 on the side. Between the two buckles 16 there is a gap 17 of suitable depth and width and shaft troughs 18 on the sidewall of the gap 17. There forms a plate 19 in the bottom of the snap-in hole 15. On the snap-in edge 13 there forms a force-exerting portion 132 for thumb to press and push. On the lower shell 20 there forms a handle 21 in the exterior, a blade compartment 60 in the interior and a blade holder 22 in the front. Please refer to FIG. 8 and FIG. 9. On the blade holder 22 there is a lock-block 23 to secure the accommodation of trapezoidal blades 40 and a lock-strip 24 to secure the accommodation of long blades 50. On the lock-strip 24 there is a magnet 241, which magnetic attraction further prevents trapezoidal blades 40 from leaving the blade holder 22. On the inner side of the blade holder 22 there forms a snap-in edge 26 with a groove 25. On the outer side of the middle of the interior there is an axle 27 with a through-hole 28. In the end of the interior there is a stop-block 29. As shown in FIG. 10, one end of the lock button 30 forms a press-block 31, while the other end forms a lock-block 32. One side of the lock-block 32 appears in bevel face 33, while on each side of the middle there is a protruding axle 34. Under the press-block 31 there is a block 35 and an elastic piece 36 with one end curving up to form a push section 37. Please refer to FIG. 11 and FIG. 12. When the lock button 30 is placed in the gap 17 between the two buckles 16 on the inner side of the upper shell 10, the axle 34 on each side can enter the shaft trough 18 of the buckle 16. And the press-block 31 is in the snap-in hole 15 of the upper shell 10. When the elastic piece 36 is locked onto the buckle 16 surface by a fixture 38, it can restrict the axle 34 of the lock button 30 without leaving the shaft trough 18, and the push section 37 of the elastic piece 36 can push against the block 35 under the press-block 31 to provide the press-block 31 with upward tension and allow the lock-block 32 in the end of the lock button 30 to horizontally protrude in the end of the upper shell 10.

Please refer to FIG. 1. When the lower shell 20 is placed into the shaft block 14 of the upper shell 10 by the axle 27 and passes through the through-hole 141, 28 of the upper shell 19 and the lower shell 2 by the fixture 70, it allows combination of the upper shell 10 and the lower shell 20 into one body, i.e. the upper shell 10 and the lower shell 20 can use the axle 27 as axle to rotate for opening or closing. Please refer to FIG. 12. Pressing down the press-block 31 of the lock button 30 makes the lock-block 32 in the terminal end to move up into the interior of the upper shell 10, allowing the release of the upper shell 10 and the lower shell 20, which is to rotate and open the upper shell 10 and the lower shell 20 to replace the blades 40, 50 in the blade holder 22 of the lower shell 20. Please refer to FIG. 13 and FIG. 14. When the upper shell 10 and the lower shell 20 rotate to close, the lock-block 32 of the lock button 30 protruding in the terminal end of the upper shell 10 uses the bevel face 33 to push against the side of the lower shell 20 and make the lock-block 32 push upward stepwise until passing the stop-block 29 of the lower shell 20. As soon as the upward force disappears, the elastic piece 36 uses tension to push the lock-block 32 downward to protrude in the inner side of the stop-block 29. In this way, the upper shell 10 and the lower shell 20 close tightly. Please refer to FIG. 15. When the upper shell 10 and the lower shell 20 complete the closing process, the snap-in edge 13 in the front of the upper shell 10 allows one side of the lower shell 20 to enter the groove 131 and adhere to the back. At the same time, the snap-in edge 26 in the front of the lower shell 20 also allows one side of the upper shell 10 to enter the groove 25 and adhere to the back. This is actually to allow the blade holder 22 in the front of the lower shell 20 to work with the restrictive surface 12 in the front of the upper shell 10 to tightly adhere to the blades 40, 50 and bear maximum deviated cutting force of the blades 40, 50 and assure the cutting safety.

From the above embodiment, it can be found that the shell opening and closing mechanism for utility knife at least possesses the following functions:

Firstly, the opening and closing between the upper shell and the lower shell can be completed by a single hand and can facilitate fast blade replacement.

Secondly, the upper shell and the lower shell combine in the middle through an axle and rotate to open or close, providing operational ease and safety for shell opening and closing for utility knife.

Thirdly, when the upper shell and the lower shell close to each other, in the front each has the snap-in edge to adhere to each other on the back and bear the maximum deviated cutting force, providing utility knife with safety.

Fourthly, because the lock button is located in the terminal end of the shells, the lower shell has more space to accommodate spare blades.

Fifthly, when the upper shell and the lower shell close to each other, the snap-in edge of the upper shell provides the thumb with stable pressing and pushing through the force-exerting portion and further prevents unexpected cutting injury due to slippage.

Specific Drawing:

(1) The designated diagram for the present invention is FIG. 1.

(2) The legends for the components

| | | | |
|---|---|---|---|
| 10 | upper shell | 11 | handle |
| 13 | snap-in edge | 132 | force-exerting portion |
| 15 | snap-in hole | 20 | lower shell |
| 22 | blade holder | 23 | lock-block |
| 24 | lock-strip | 241 | magnet |
| 26 | snap-in edge | 29 | stop-block |
| 31 | press-block | 40 | trapezoidal blade |
| 50 | long blade | 60 | blade compartment |
| 70 | fixture | | |

### BRIEF DESCRIPTION OF THE DRAWINGS

FIG. 1 is an embodiment to illustrate the shell opening and closing for the utility knife in the invention.

FIG. 2 is the side view for the upper shell for the utility knife in the invention.

FIG. 3 is the top view for the upper shell for the utility knife in the invention.

FIG. 4 is the cutaway view in A direction for FIG. 2.

FIG. 5 is the side view for the lower shell for the utility knife in the invention.

FIG. 6 is the top view for the lower shell for the utility knife in the invention.

FIG. 7 is the cutaway view in A direction for FIG. 6.

FIG. 8 is an illustration of the placement of trapezoidal blades in the front of the lower shell of the utility knife in the invention.

FIG. 9 is an illustration of the placement of long blades in the front of the lower shell of the utility knife in the invention.

FIG. 10 is the exterior view for the lock button in the invention.

FIG. 11 is an illustration of the lock button assembled in the upper shell in the invention.

FIG. 12 is an illustration of the lock button releasing and locking in the invention.

FIG. 13 is an illustration of the lock button ready to be locked in the invention.

FIG. 14 is an illustration of the lock button to complete locking in the invention.

FIG. 15 is an illustration of the front assembly when the shells close for the utility knife in the invention.

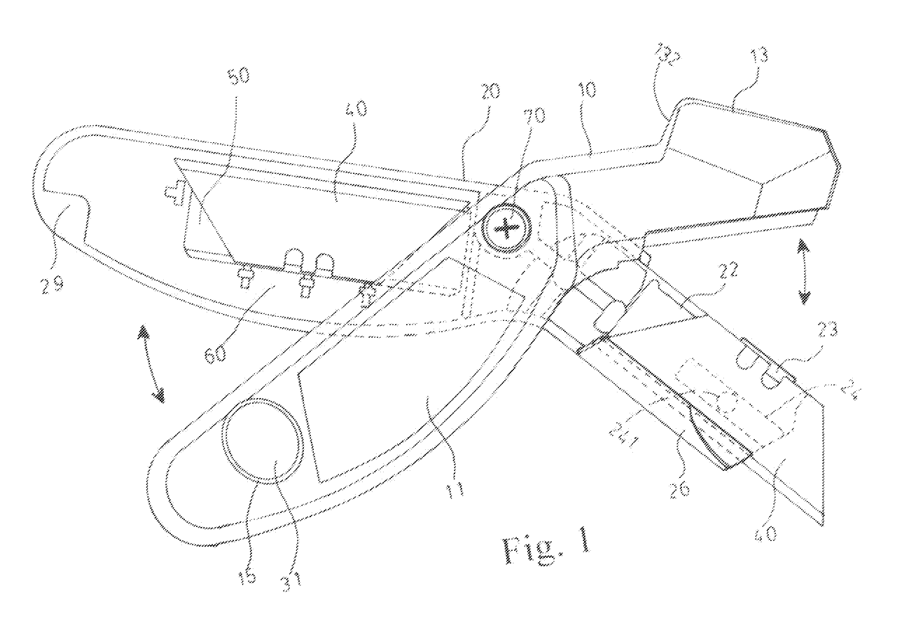

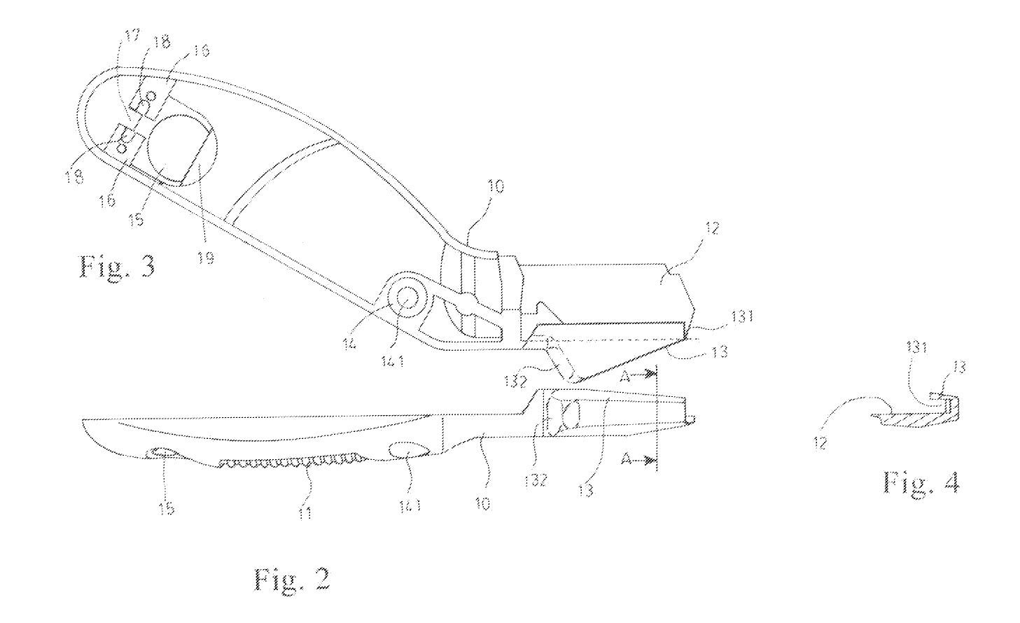

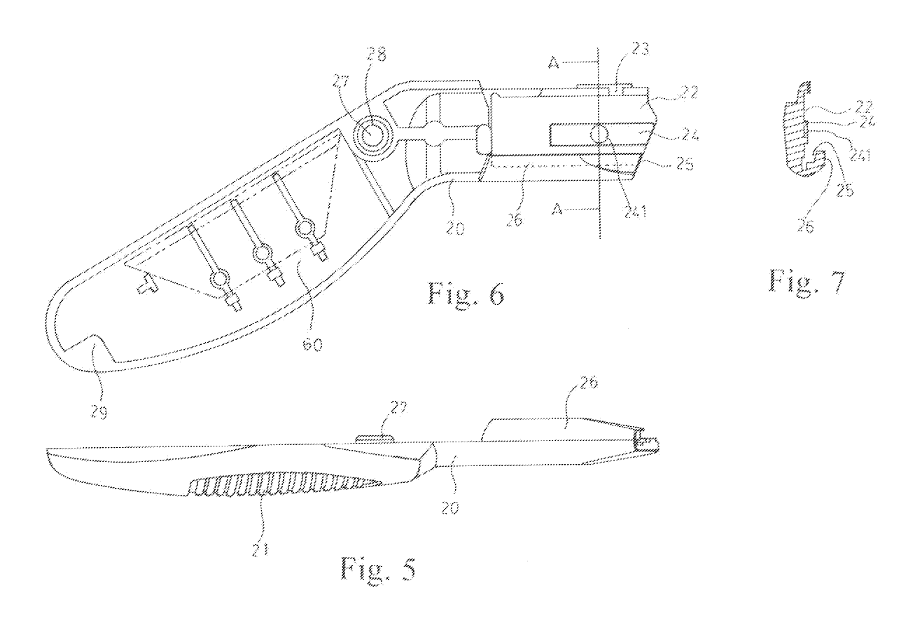

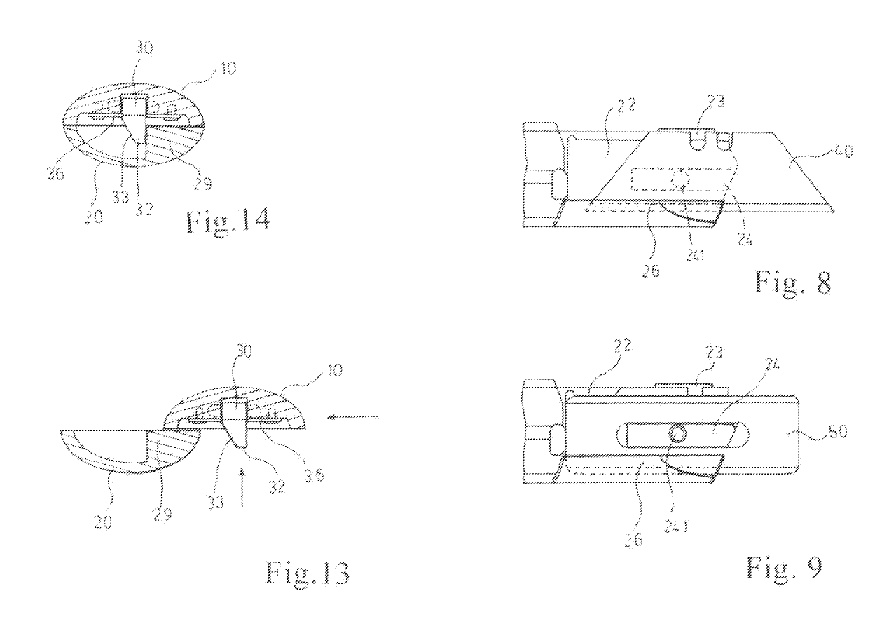

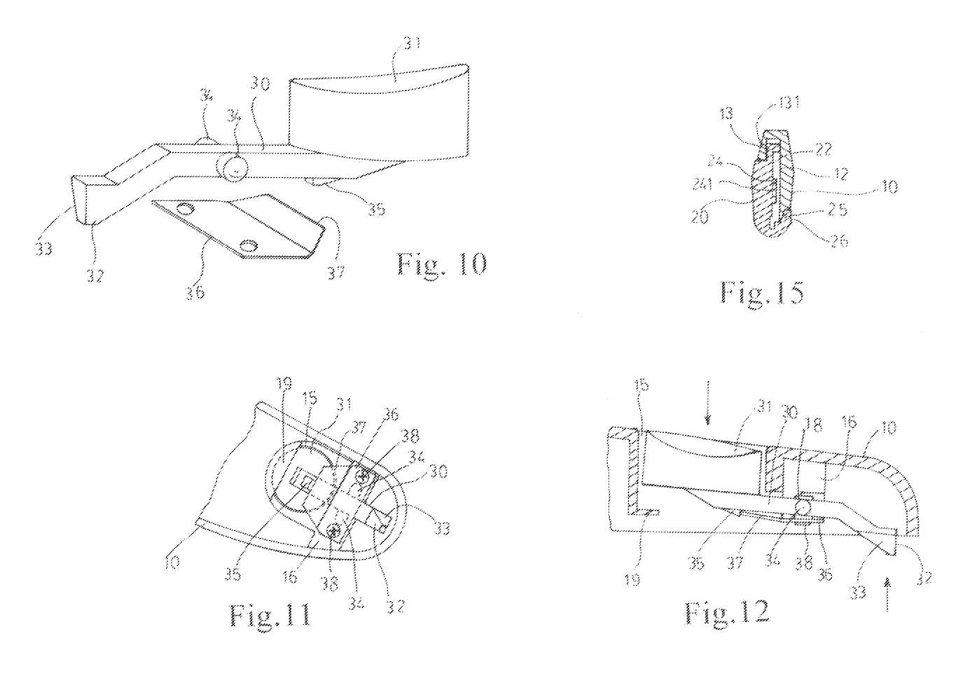

What is claimed is:

1. A shell opening and closing mechanism for utility knife comprises an upper shell, a lower shell and a lock button in the terminal end of the upper shell.
For the upper shell, its inner front forms a blade restrictive surface. For the restrictive surface, its outer side of forms a snap-in edge with a groove, and near the outer side of its inner middle section there is a shaft block with a through-hole, and near the end of the inner side there is a snap-in hole and two side buckles, a gap between the two buckles and a shaft trough on one sidewall of the gap. The bottom of the snap-in hole forms a plate on one side.
For the lower shell, at the blade holder in the inner front there is a lock-block and a lock-strip. The inner side of the blade holder forms a snap-in edge with a groove. Near the outer side of its inner middle, there is an axle with a through-hole. At the terminal end of inner side, there is a stop-block.
For the lock button, one end forms a press-block, while the other end forms a lock-block. One side of the lock-block appears in bevel face. In the middle, there is an axle on each side. Under the press-block, there is a block, an elastic piece and a push section curving up at one end.
The assembly of the above components constitutes a shell opening and closing mechanism for utility knife.

2. According to the description in claim 1 for a shell opening and closing mechanism for a utility knife, the assembly of the upper shell and the lower shell utilizes the combination of an axle and a shaft block and enables shell opening and closing by rotation.

3. According to the description in claim 1 for a shell opening and closing mechanism for a utility knife, the upper shell allows the outer side of the lower shell to enter the groove on the outer side of the restrictive surface and therefore the snap-in edge can adhere tightly to the back of the lower shell.

4. According to the description in claim 1 for a shell opening and closing mechanism for a utility knife, the lower shell allows the inner side of the upper shell to enter the groove on the inner side of the blade holder and therefore the snap-in edge can adhere tightly to the back of the upper shell.

5. According to the description in claim 1 for a shell opening and closing mechanism for a utility knife, the lock button is assembled and locked onto the buckle of the upper shell through an elastic piece, which provides upward tension and enables its end to protrude horizontally in the terminal end of the upper shell.

6. According to the description in claim 1 for a shell opening and closing mechanism for a utility knife, the snap-in edge of the upper shell forms a force-exerting portion for the thumb to press and push.

7. According to the description in claim 1 for a shell opening and closing mechanism for a utility knife, on the lock-strip of the blade holder of the lower shell, there is a magnet.
